(19) United States
(12) Patent Application Publication
(10) Pub. No.: US 2016/0057406 A1
(43) Pub. Date: Feb. 25, 2016

(54) THREE-DIMENSIONAL IMAGE ACQUISITION SYSTEM

(71) Applicant: VIT, Saint-Egreve (FR)

(72) Inventors: Mathieu PERRIOLLAT, Saint Egreve (FR); Ke-Hua LAN, Saint Egreve (FR)

(73) Assignee: VIT, Saint Egreve (FR)

(21) Appl. No.: 14/783,482

(22) PCT Filed: Apr. 8, 2014
(86) PCT No.: PCT/FR2014/050840

§ 371 Date: Oct. 9, 2015

(30) Foreign Application Priority Data
Apr. 9, 2013 (FR) 1353170

(51) Int. Cl. H04N 13/02; G01B 11/245; H04N 5/225; G01B 11/25

(52) U.S. Cl. CPC H04N 13/0242; G01B 11/25; G01B 11/245; H04N 5/2256

(57) ABSTRACT

A three-dimensional image acquisition system including: at least two projectors aligned in a direction and suitable for illuminating a scene, the projection axes of the projectors defining a plane for each projector, and being turned toward the scene. A first and second camera are placed on one side of said plane, and a third and fourth camera placed on the other side of said plane. The optical axis of the first and second cameras form, with said plane, a different first and second angle, respectively, and the optical axis of the third and fourth cameras form, with said plane, a different third and fourth angle, respectively.

The present patent application claims the priority benefit of French patent application FR13/53170 which is herein incorporated by reference.

### BACKGROUND

The present disclosure generally relates to optical inspection systems and, more specifically, to three-dimensional image determination systems intended for the on-line analysis of objects, particularly of electronic circuits. The disclosure more specifically relates to such an acquisition system which rapidly and efficiently processes the obtained information.

### DISCUSSION OF THE RELATED ART

Three-dimensional image acquisition systems are known. For example, in the field of printed circuit board inspection, it is known to illuminate a scene by means of one or a plurality of pattern projectors positioned above the scene and, by means of one or of two monochrome or color cameras, to detect the shape of the patterns obtained on the three-dimensional scene. An image processing is then carried out to reconstruct the three-dimensional structure of the observed scene.

A disadvantage of known devices is that, according to the three-dimensional structure of the scene to be observed, and especially to the level differences of this structure, the reconstruction may be of poor quality.

There thus is a need for a three-dimensional image acquisition system overcoming all or part of the disadvantages of prior art.

### SUMMARY

Document DE19852149 describes a system for determining the space coordinates of an object using projectors and cameras.

Document US-A-2009/0169095 describes a method for generating structured light for three-dimensional images.

An object of an embodiment is to provide a three-dimensional image acquisition device implying fast and efficient image processing operations, whatever the shape of the three-dimensional scene to be observed.

Thus, an embodiment provides a three-dimensional image acquisition device, comprising:
at least two projectors aligned along a direction and capable of illuminating a scene, the projection axes of the projectors defining a plane;
for each projector, and facing the scene, a first and a second camera placed on one side of said plane and a third and a fourth camera placed on another side of said plane, the optical axis of the first and second cameras respectively forming with said plane a first and a second different angles, the optical axis of the third and fourth cameras respectively forming with said plane a third and a fourth different angle.

According to an embodiment, the optical axes of the first, second, third, and fourth cameras are perpendicular to said direction.

According to an embodiment, the first and third angles are equal and the second and fourth angles are equal, to within their sign.

According to an embodiment, for each projector, the optical axes of the first and third cameras are coplanar and the optical axes of the second and fourth cameras are coplanar.

According to an embodiment, for each projector, the optical axes of the first and fourth cameras are coplanar and the optical axes of the second and third cameras are coplanar.

According to an embodiment, all cameras are interposed between the projectors in said direction.

According to an embodiment, the device further comprises blue-, red-, green- or white-colored alternated illumination devices.

According to an embodiment, the first angle is greater than 18° and is smaller than the second angle, the interval between the first and the second angle being greater than 10°, and the third angle is greater than 18° and smaller than the fourth angle, the interval between the third and the fourth angle being greater than 10°.

According to an embodiment, the illumination devices are interposed between each of the projectors and are capable of illuminating the scene.

According to an embodiment, each of the first and second cameras comprises an image sensor inclined with respect to the optical axis of the camera.

### BRIEF DESCRIPTION OF THE DRAWINGS

The foregoing and other features and advantages will be discussed in detail in the following non-limiting description of specific embodiments in connection with the accompanying drawings, among which:

FIG. 1 illustrates a three-dimensional image acquisition system;

FIG. 2 is a side view of the system of FIG. 1;

FIG. 3 illustrates an acquisition system according to an embodiment;

FIG. 4 is a side view of an acquisition system according to an embodiment;

FIGS. 5 and 6 are top views of two acquisition systems according to embodiments; and

FIGS. 7A and 7B illustrate patterns capable of being used in a system according to an embodiment.

For clarity, the same elements have been designated with the same reference numerals in the different drawings.

### DETAILED DESCRIPTION

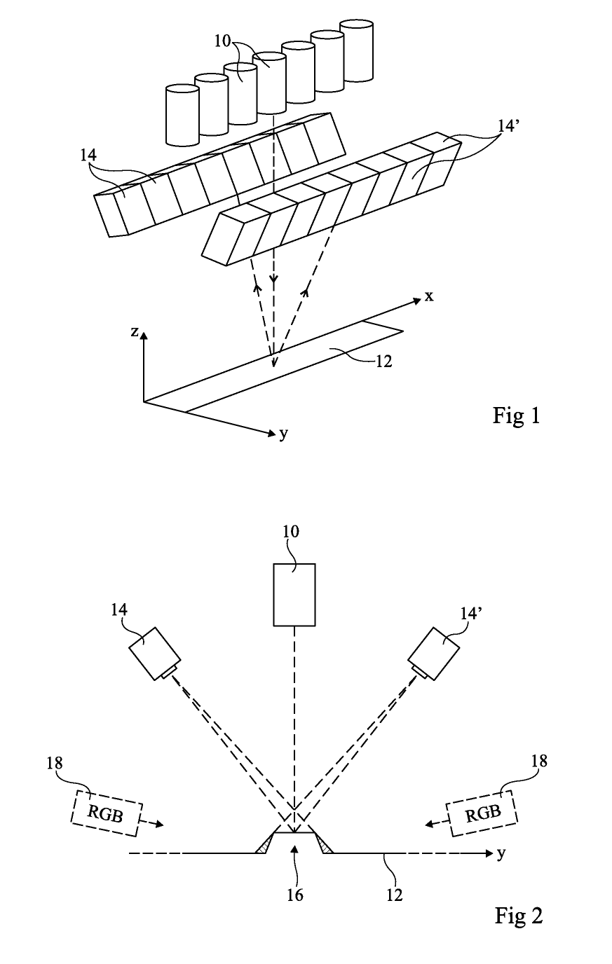

FIG. 1 is a simplified perspective view of a three-dimensional image acquisition device such as described in European patent application published under number EP 2413095. FIG. 2 is a side view of the device of FIG. 1, positioned above a scene in relief.

The device of FIG. 1 comprises a plurality of projectors 10 placed vertically above a three-dimensional scene 12. Scene 12, or observation plane, extends along two axes x and y, and projectors 10 have projection axes in this example parallel to a third axis z. Scene 12 is provided to be displaced, between each image acquisition step, along the direction of axis y.

Projectors 10 are aligned with one another along axis x, and their projection axes define a plane (to within the projector alignment) which will be called projector plane hereafter. Projectors 10 are directed towards scene 12. It should be noted that projectors 10 may be provided so that their beams slightly overlap at the level of scene 12.

Two groups of cameras 14 and 14′, for example, monochrome, are aligned along two lines parallel to direction x, the cameras facing scene 12. In this example, each group 14, 14′ comprises cameras each positioned on either side of projectors 10 in direction x (a total of four cameras per projector). The two groups 14 and 14′ are placed on either side of projectors 10 and, more specifically, symmetrically with respect to the above-defined projector plane. Opposite cameras 14 and 14′ are positioned so that their respective optical axes extend in the shown example in a plane perpendicular to the direction of axis x and are paired up, a camera of each group aiming at the same point as the camera of the other group which is symmetrical thereto. This amounts to inclining all the cameras by a same angle relative to vertical axis z. Cameras 14 may have overlapping fields of vision on scene 12 (for example, with a 50% overlap). The cameras are connected to an image processing device (not shown).

Projectors 10 are arranged to project on scene 12 (in the shooting area) a determined pattern which is recognized by the processing system, for example, binary fringes. In the case of fringe shape detection devices, an image of the patterns may be displayed and directly projected by the digital projector, the fringes being provided to overlap at the intersections of illumination from the different projectors. Knowing the illumination pattern(s), the parameters of the projectors, and the camera parameters, the information of altitude in the scene can be obtained, and thus a three-dimensional reconstruction thereof can be achieved. The fringes extend in this example parallel to axis x.

FIG. 2 is a side view of the device of FIG. 1, in a plane defined by axes z and y. FIG. 2 illustrates a portion of scene 12 which comprises a non-planar region 16.

This drawing shows a single projector 10 and two cameras 14 and 14′, the angle between the illumination axis of projector 10 and the optical axis of camera 14 being equal to the angle between the illumination axis of projector 10 and the optical axis of camera 14′.

The projection of patterns by projector 10 on non-planar region 16 implies a deformation of these patterns in the observation plane, detected by cameras 14 and 14′. However, as shown in hatched portions in FIG. 2, some portions of scene 12 are not seen by at least one of the cameras. This mainly concerns regions very close to raised region such as region 16. Such a phenomenon is called shadowing.

When there is a shadowing, the three-dimensional reconstruction becomes complex. A fine optical configuration of a three-dimensional image acquisition head should be able to ensure a fast acquisition of the necessary images and an accurate reconstruction of the 3D scene along the three axes, with a good reliability (no shadowing, good reproducibility). This is not easy with existing devices, since it is particularly expensive and/or sub-optimal in terms of acquisition speed.

It should further be noted that the greater the detection angle (angle between the illumination axis of the projector and the optical axis of the associated camera, with a 90° upper limit), the higher the three-dimensional detection sensitivity. However, the increase of this angle increases shadowing effects. It should also be noted that the maximum triangulation angle, which corresponds to the angle between the camera and the projector if the triangulation is performed between these elements, or to the angle between two cameras if the triangulation is performed therebetween, is equal to 90°.

As shown in dotted lines in FIG. 2, it is current to provide additional illumination devices 18 (RGB or white), for example, non-polarized in the present example, for example placed on either side of the projector plane, forming a significant angle therewith (grazing illumination). Additional color illumination devices 18 enable to illuminate the scene so that two-dimensional color images may also be formed, concurrently to the three-dimensional reconstruction. Such a coupling of two detections, a three-dimensional monochrome detection and a two-dimensional color detection, ascertains the reconstruction of a final three-dimensional color image by the processing means.

A disadvantage of the structure of FIG. 2 comprising grazing illumination devices is that this limits the positioning of the cameras on either side of the projection plane. Indeed, cameras 14 and 14′ cannot be placed too close to projectors 10 (small angle between the projected beam and the optical axis of the cameras), otherwise the cameras are in the area of specular reflection of the beams provided by projectors 10, which adversely affects the detection. Further, cameras 14 and 14′ cannot be placed too far from projectors 10 (large angle between the projected beam and the optical axis of the cameras), otherwise the cameras are placed in the area of specular reflection of the beams provided by additional grazing illumination devices 18. This last constraint implies a limited resolution along axis z of the 3D reconstruction. In practice, the detection angle (angle between the projected beam and the optical axis of the cameras) may be limited by such constraints to a range of values from 18° to 25°.

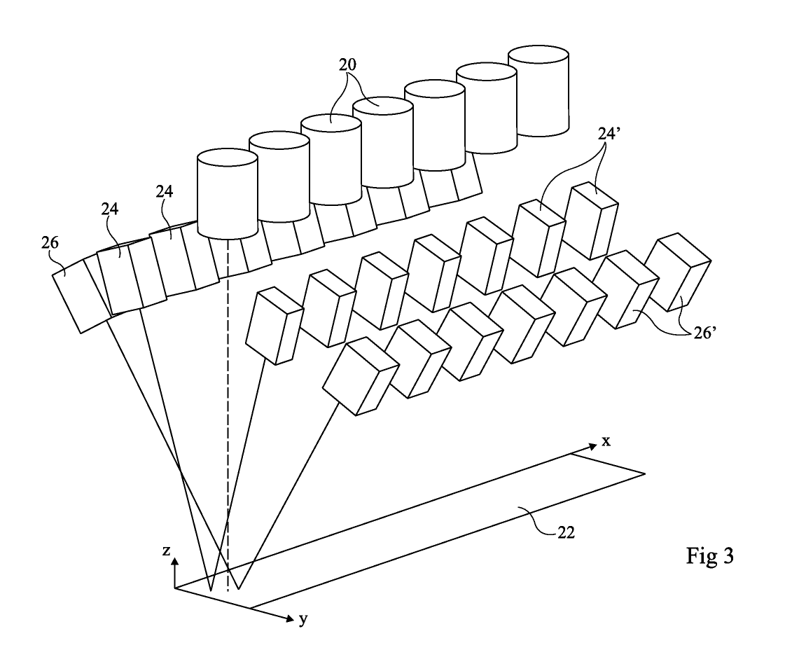

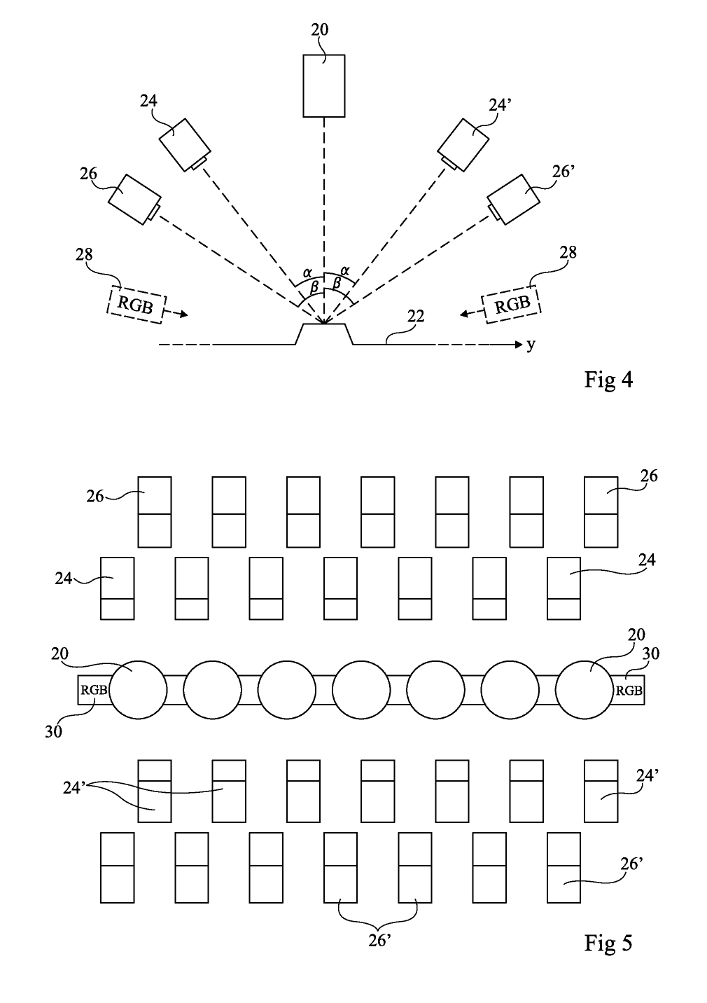

FIG. 3 illustrates a three-dimensional image acquisition system according to an embodiment and FIG. 4 is a side view of the acquisition system of FIG. 3.

A three-dimensional image acquisition system comprising a row of projectors 20 placed vertically above a scene 22 is here provided. Scene 22 extends along two axes x and y and the illumination axis of projectors 20 is in this example parallel to a third axis z. The scene, or the acquisition head, is provided to be displaced, between each image acquisition, along the direction of axis y. The device may comprise two or more projectors 20.

Projectors 20 are aligned with one another along the direction of axis x, are directed towards scene 22, and their projection axes define a plane which will be called projector plane hereafter.

Four groups of cameras 24, 24′, 26, 26′ are aligned along four lines parallel to direction x, cameras 24, 24′, 26, 26′ facing scene 22. The optical axes of each of cameras 24, 24′, 26, 26′ are included in the shown example within planes perpendicular to axis x. Thus, cameras 24 are aligned along the direction of axis x, as well as cameras 24′, cameras 26, and cameras 26′. Two groups of cameras 24 and 26 are placed on one side of the projector plane and two groups of cameras 24′ and 26′ are placed on the other side of the projector plane. Groups 24 and 24′ may be placed symmetrically on either side of projectors 20, and groups 26 and 26′ may be placed symmetrically on either side of projectors 20, as illustrated in FIGS. 3 and 4.

Opposite cameras 24 and 24′, respectively 26 and 26′, are positioned so that their respective optical axes are, in the shown example, perpendicular to axis x and are paired up. This amounts to inclining the cameras of groups 24 and 24′ by a same angle relative to vertical axis z and to inclining the cameras of groups 26 and 26′ by a same angle relative to vertical axis z. The angle may be identical (to within the sign) for the cameras of groups 24 and 24′ and for the cameras of groups 26 and 26′. The field of view of each camera is preferably defined so that each area of the scene in the processed fields is covered by four cameras. As a variation, different angles for each of the cameras associated with a projector may be provided. Cameras 24, 26, 24′, and 26′ are connected to an image processing device (not shown).

In practice, each projector has four associated cameras, one from each of groups 24, 24′, 26, 26′. The different alternative arrangements of the cameras relative to the projectors will be described hereafter in further detail in relation with FIGS. 5 and 6.

Projectors 20 are arranged to project on scene 22 (in the shooting area) a determined pattern which is recognized by the processing device, for example, binary fringes. In the case of pattern shape detection devices, an image of the patterns may be directly displayed and projected by the digital projectors to overlap at the intersections of illumination from the different projectors, for example, as described in patent applications EP 2413095 and EP 2413132. Knowing the illumination patterns, the parameters of the projectors and the camera parameters, information of altitude in the scene can be obtained, thus allowing a three-dimensional reconstruction thereof.

Advantageously, the forming of two rows of cameras on either side of the projector plane at different orientation angles ascertains an easy detection of the three-dimensional structure, with no shadowing issue, as well as a fast processing of the information.

Indeed, the use of four cameras per projector, positioned according to different viewing angles (angles between the projected beam and the optical axis of the camera) ensures a reliable detection limiting shadowing phenomena and a good reproducibility, while ensuring a fast acquisition of the images necessary for the reconstruction, in the three directions, of the elements forming the scene.

This is due to the fact that each portion of scene 22 is seen by four cameras with different viewing angles, which ensures a significant resolution of the 3D reconstruction. Further, to increase the resolution and the reliability of reconstruction of 3D images, rather than projecting binary fringes, it may be provided to use a series of sinusoidal fringes phase-shifted in space, for example, grey, that is, slightly offset between each acquisition, one acquisition being performed for each new phase of the projected pattern. Projectors 20 project all at the same time one of the phases of the patterns and the cameras acquire at the same time the images of the fringes deformed by the scene, and so on for each dimensional phase-shift of the patterns. As an example, at least three phase-shifts of the patterns may be provided, for example, 4 or 8, that is, for each position of the acquisition device at the surface of the scene, at least three acquisitions are provided, for example, 4 or 8 acquisitions.

Finally, the positioning of the cameras according to different viewing angles on either side of the projector plane ensures a reconstruction of the three-dimensional images, even in cases where shadowing phenomena would have appeared with the previous devices: in this case, the 3D reconstruction is performed, rather than between two cameras placed on either side of the projector plane, between two cameras placed on the same side of the projector plane. This provides a good three-dimensional reconstruction, in association with an adapted information processing device.

In the same way as in existing devices, a portion of the projection field of a projector may be covered with those of adjacent projectors. The projection light of each projector may be linearly polarized along one direction, and the cameras may be equipped with a linear polarizer at the entrance of their field of view to stop most of the light from the projector reflecting on objects (specular reflection). Further, the image sensor placed in each of the cameras may be slightly inclined to have a clearness across the entire image of the inclined field of the camera.

A 3D image reconstruction digital processing is necessary, based on the different images of deformed patterns. Two pairs of detection cameras placed around each projector enable to obtain a 3D super-resolution. Since each projection and detection field is partially covered with those of the adjacent projectors and cameras, a specific images processing may be necessary and will not be described in detail herein.

FIG. 4 shows the device of FIG. 3 in side view. This drawing only shows one projector 20 and one camera from each group 24, 24′, 26, and 26′. Call α the angle between the axis of projector 20 (axis z) and the optical axis of cameras 24 and 24′ and call β the angle between axis z and the optical axis of cameras 26 and 26′. In the example of FIG. 4, α<β.

It should be noted that angles α and β may be different for each of the cameras of the different groups, the general idea here being to associate, with the beam originating from each projector, at least four cameras having optical axes which may be in a plane perpendicular to axis x, or not, and having optical axes forming at least two different angles with the projection axis on either side of the projector plane.

As illustrated in FIG. 4, an optional peripheral grazing illumination 28 (RGB), non-polarized in this example, may be provided in the device of FIGS. 3 and 4. In this case, and in the same way as described in relation with FIGS. 1 and 2, minimum angle α is equal to 18° to avoid for the field of view of the cameras to be in the specular reflection field of projectors 20. Further, maximum angle β may be 25° to avoid for the field of view of the cameras to be in the field of specular reflection of the color peripheral grazing illumination, according to the type of illumination. It should be noted that, for the 3D reconstruction to be performed properly, a minimum difference of at least 10° between angles α and β, preferably of at least 15°, should be provided.

As an alternative embodiment, the peripheral grazing illumination may be replaced with an axial illumination, having its main projection direction orthogonal to observation plane 22, that is, parallel to axis z. This variation provides a placement of the different groups of cameras 24, 24′, 26, and 26′ according to angles β which may range up to 70°. This allows a three-dimensional detection having a high sensitivity, since the detection angle may be large.

According to the type of illumination used for the axial color illumination, the minimum detection angle of cameras 24 and 24′ (angle α) may be in the order of 18°, to avoid for the cameras to be placed in the area of specular reflection of the axial color illumination.

It should be noted that the maximum value of 70° for angle β has been calculated for a specific application of use of the inspection system, that is, the inspection of printed circuit boards. Indeed, on such a board, elements in the observation field may have dimensions in the order of 200 μm, may be separated by a pitch in the order of 400 μm, and may have a thickness in the order of 80 μm. A maximum angle of 70° for the observation cameras ascertains that an object in the observation field is not masked by a neighboring object. However, this maximum angle may be different from that provided herein in the case of applications where the topologies are different from those of this example.

In practice, if the cameras are monochrome, they acquire, after each set of 3D image acquisitions, three images for each of the red, green, and blue components (R, G, B) of the RGB color illumination, be it peripheral or axial. The 2D color image is then reconstructed from the images of the red, green, and blue components. A combination of the 3D monochrome and 2D color images enables to reconstruct a 3D color image. A white light source may as a variation be provided for a 2D color image with associated color cameras.

As an example of digital applications, in the case of a peripheral grazing RGB color illumination, the average value (if a plurality of angles α are provided for cameras 24 and 24′) of angle α, for cameras 24 and 24′, may be provided to be equal to 18° and the average value (if a plurality of angles β are provided for cameras 26 and 26′) of angle β, for cameras 26 and 26′, may be provided to be equal to 25°. In the case of an axial RGB color illumination, the average value (if a plurality of angles α are provided for cameras 24 and 24′) of angle α, for cameras 24 and 24′, may be provided to be equal to 21° and the average value (if a plurality of angles β are provided for cameras 26 and 26′) of angle β, for cameras 26 and 26′, may be provided to be equal to 36°.

FIGS. 5 and 6 are top views of two acquisition devices according to embodiments, where an axial RGB color illumination 30 is provided. It should be noted that the two alternative positionings of the cameras illustrated in FIGS. 5 and 6 are also compatible with the forming of an inspection device comprising a peripheral grazing color illumination device (28).

In the two drawings, an axial RGB color illumination is provided. As illustrated, illumination elements 30 of this illumination system are interposed between each of projectors 20, their main illumination direction being parallel to axis z.

In the example of FIG. 5, cameras 24 are positioned with the same angle α as cameras 24′, and cameras 26 are positioned with the same angle β as cameras 26′. Further, cameras 24 are positioned along axis x at the same level as cameras 26′ (the optical axis of a camera 24 is coplanar to the optical axis of a camera 26′), and cameras 26 are positioned along axis x at the same level as cameras 24′ (the optical axis of a camera 26 is coplanar to the optical axis of a camera 24′). Cameras 24, 24′, 26, and 26′ are positioned along axis x so that a group of four cameras, each belonging to one of groups 24, 24′, 26, and 26′, surrounds a projector 20. Thus, the pitch separating each of the cameras of a group 24, 24′, 26, and 26′ is identical to the pitch separating each of projectors 20. The cameras are placed along axis x with an offset of 25% of the pitch of the projectors on either side of projectors 20.

According to an alternative embodiment, not shown, two cameras located at the same level along axis x may be placed on this axis at the same level as the associated projector 20, and the adjacent cameras along axis x are positioned, along axis x, in the middle between two adjacent projectors.

In the example of FIG. 6, cameras 24 are positioned with the same angle α as cameras 24′, and cameras 26 are positioned with the same angle β as cameras 26′. Further, cameras 24 are positioned along axis x at the same level as cameras 24′ (the optical axis of a camera 24 is coplanar to the optical axis of a camera 24′), and cameras 26 are positioned along axis x at the same level as cameras 26′ (the optical axis of a camera 26 is coplanar to the optical axis of a camera 26′). Further, cameras 24, 24′, 26, and 26′ are positioned along axis x so that a group of four cameras, each belonging to one of groups 24, 24′, 26, and 26′, surrounds a projector 20. Thus, the pitch separating each of the cameras of a group 24, 24′, 26, and 26′ is identical to the pitch separating each of projectors 20. The cameras are placed along axis x with an offset of 25% of the pitch of the projectors on either side of projectors 20.

According to an alternative embodiment, not shown, two cameras located at the same level along axis x may be placed on this axis at the same level as the associated projector 20, and the adjacent cameras along axis x are positioned, along axis x, in the middle between two adjacent projectors.

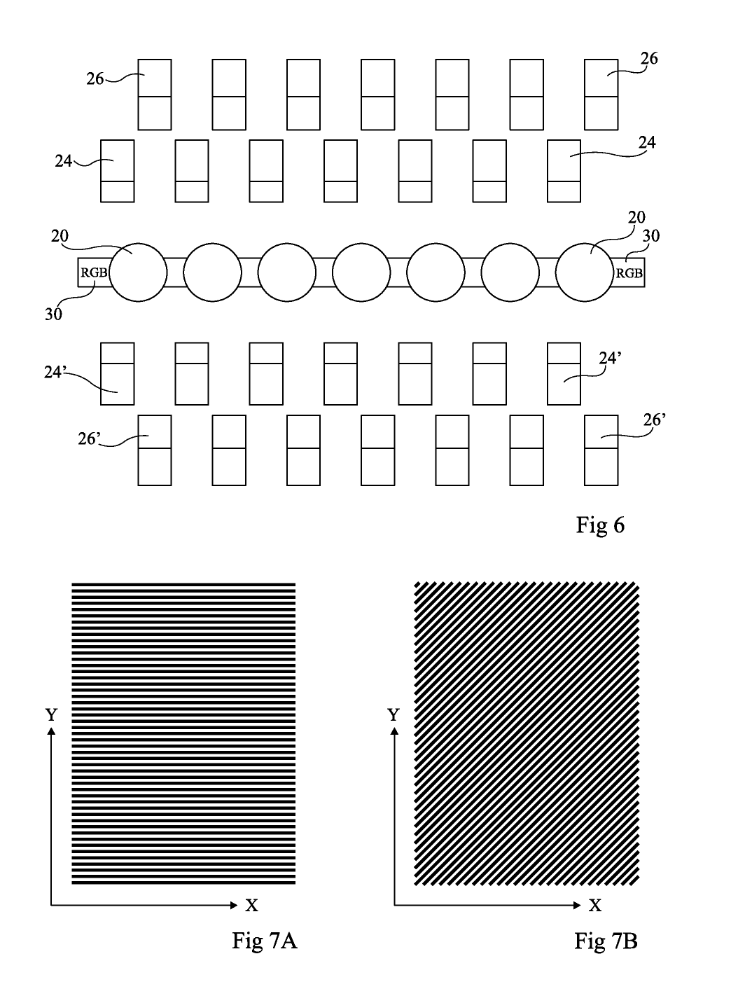

FIGS. 7A and 7B illustrate patterns projected by a device according to an embodiment.

With the devices of FIGS. 3 to 6, and with the above alternative positionings, each of projectors 20 may be provided to project sinusoidal patterns successively phase-shifted for each acquisition by the cameras.

FIG. 7A illustrates such patterns which conventionally extend along axis x. Before each acquisition by the cameras, for a position of the acquisition system above the scene, that is, before each of the 4 or 8 acquisitions, for example, the pattern is offset along axis y by a 2π/4 or 2π/8 phase-shift.

FIG. 7B illustrates a pattern variation particularly adapted to acquisition systems according to an embodiment. In this variation, the sinusoidal fringes forming the pattern do not extend along axis x but extend according to an angle in plane x/y.

It should be noted that this configuration is particularly adapted to the embodiment of FIG. 5 where four cameras surrounding a projector 20 are positioned on either side of the projector plane, in top view, according to a same diagonal in plane x/y. In this case, it is provided to form patterns extending in plane x/y according to an angle perpendicular to the alignment diagonal of the cameras on either side of the plane of the projectors in plane x/y. This enables to further improve the three-dimensional resolution along axis z.

In the case where the four cameras associated with a projector are placed symmetrically with respect to the projector plane (example of FIG. 6), the fringes may also be provided to extend according to an angle in plane x/y. In this case, the resolution of a single pair of cameras on one side of the projector plane is increased.

The digital processing enabling to take advantage of the information from the different cameras of the devices according to an embodiment will not be described in further detail. Indeed, knowing the illumination pattern(s), the parameters of the different projectors and the camera parameters, information of altitude in the scene (and thus the three-dimensional reconstruction) may be obtained by means of conventional calculation and image processing means programmed for this application. If each projection and detection field is partially covered by those of the adjacent projectors and cameras, a specific processing of the images may be necessary. It may also be provided to only use one projector out of two at a time to avoid overlaps of the illumination fields, such a solution however implying a longer acquisition time. The two-dimensional color image of the objects may be reconstructed from the red, green, and blue (RGB) images, and the 3D color image may be reconstructed by a combination of all these acquisitions.

Specific embodiments have been described. Various alterations and modifications will occur to those skilled in the art. In particular, the variations of FIGS. 3 to 6 may be combined or juxtaposed in a same device if desired. Further, as seen previously, angles α and β may be different for each of the cameras of the different groups, the general idea here being to associate, with each of the projectors, at least four cameras having their optical axes forming at least two different angles with the projector plane on either side thereof. Further, the optical axes of the cameras may be perpendicular to the alignment axis of the projectors. It should be noted that the four cameras associated with a projector may also all have non-coplanar optical axes.

It should further be noted that a system comprising more than four cameras per projector may also be envisaged. Finally, devices where the optical axes of the different cameras associated with a projector are in planes perpendicular to axis x have been discussed herein. It should be noted that these optical axes may also be in planes different from them.

Various embodiments with different variations have been described hereabove. It should be noted that those skilled in the art may combine various elements of these various embodiments and variations without showing any inventive step.

1. A three-dimensional image acquisition device comprising:
at least two projectors aligned along a direction and capable of illuminating a scene, the projection axes of the projectors defining a plane;
for each projector, and facing the scene, a first and a second camera placed on one side of said plane and a third and a fourth camera placed on another side of said plane, the optical axis of the first and second cameras respectively forming with said plane a first and a second different angles, the optical axis of the third and fourth cameras respectively forming with said plane a third and a fourth different angle; and
blue-, red-, green-, or white-colored alternated illumination devices.

2. The device of claim 1, wherein the optical axes of the first, second, third, and fourth cameras are perpendicular to said direction.

3. The device of claim 1, wherein the first and third angles are equal and the second and fourth angles are equal, to within their sign.

4. The device of claim 1, wherein, for each projector, the optical axes of the first and third cameras are coplanar and the optical axes of the second and fourth cameras are coplanar.

5. The device of claim 1, wherein, for each projector, the optical axes of the first and fourth cameras are coplanar and the optical axes of the second and third cameras are coplanar.

6. The device of claim 1, wherein all cameras are interposed between the projectors in said direction.

7. The device of claim 1, wherein the first angle is greater than 18° and is smaller than the second angle, the interval between the first and the second angle being greater than 10°, and the third angle is greater than 18° and smaller than the fourth angle, the interval between the third and the fourth angle being greater than 10°.

8. The device of claim 1, wherein the illumination devices are interposed between each of the projectors and are capable of illuminating the scene.

9. The device of claim 1, wherein each of the first and second cameras comprises an image sensor inclined with respect to the optical axis of the camera.
